(19) United States
(12) Patent Application Publication
(10) Pub. No.: US 2024/0353901 A1
(43) Pub. Date: Oct. 24, 2024

(54) COMPUTER DEVICE, COMPUTER SYSTEM AND METHOD FOR OPERATING COMPUTER DEVICE

(71) Applicant: OPROCESSOR INC, BOSTON, MA (US)

(72) Inventors: Sahnggi PARK, Daejeon (KR); Ellison Hyunjong PARK, Daejeon (KR)

(21) Appl. No.: 18/506,557

(22) Filed: Nov. 10, 2023

(30) Foreign Application Priority Data
Apr. 21, 2023 (KR) 10-2023-0052546
Aug. 2, 2023 (KR) 10-2023-0100946

(51) Int. Cl. G06F 1/18; B01D 46/00; B01D 46/44; B01D 46/46; B01D 46/84; B01D 53/26; B01D 53/28

(52) U.S. Cl. CPC G06F 1/182; B01D 46/0036; B01D 46/448; B01D 46/46; B01D 46/84; B01D 53/261; B01D 53/28; B01D 2253/10; B01D 2257/80; B01D 2279/45

(57) ABSTRACT

Provided is a computer device. The computer device includes a case including a first opening, an intake filter box exposed through the first opening of the case, a main board within the case, and a power supply device within the case. The intake filter box includes a first air inflow surface exposed through the first opening, a first air discharge surface opposite to the first air inflow surface, and first moisture absorbents between the first air inflow surface and the first air discharge surface. Each of the first air inflow surface and the first air discharge surface includes a hole.

### CROSS-REFERENCE TO RELATED APPLICATIONS

This U.S. non-provisional patent application claims priority under 35 U.S.C. § 119 of Korean Patent Application Nos. 10-2023-0052546, filed on Apr. 21, 2023, and 10-2023-0100946, filed on Aug. 2, 2023, the entire contents of which are hereby incorporated by reference.

### BACKGROUND

The present disclosure herein relates to a computer device, a computer system, and a method for operating the computer device. More particularly, the present disclosure relates to a computer device including a temperature and humidity controller, a computer system, and a method for operating the computer device.

Computers may perform high-speed operations and data processing using microprocessors and large-capacity memories. Various characters, graphics, and videos may be displayed on a monitor by the computer device, and voices may be implemented through a speaker.

Personal computers capable of being used for personal work processing purposes have been developed and then are widely used due to gradual improvement in performance and price decline of computer components. Such a personal computer usually has a main board with a central processing unit (CPU), and a graphic card, a hard disk, and a power supply unit installed inside a case.

With the development of optical communication technologies, an HDMI cable connecting a computer to a monitor may be manufactured to a length of more than about 300 m. A length of an USB cable may also be manufactured to be sufficiently long. Therefore, there is no need to place the computer close to a user input/output device such as the monitor and the keyboard, and the level of computer congestion is improving. However, when the computer is placed far away from the user input/output device, a space in which the computer is placed may be more humid and dusty than a space in which the user input/output device is placed. Therefore, researches of protecting the computer from the humidity and dust are needed.

### SUMMARY

The present disclosure provides a computer device capable of protecting its components from humidity and dust, a computer system, and a method for operating the computer device.

The present disclosure also provides a computer device capable of being disposed in a space that is far away from a space in which a user input/output device is disposed.

An embodiment of the inventive concept provides a computer device including: a case including a first opening; an intake filter box exposed through the first opening of the case; a main board within the case; and a power supply device within the case, wherein the intake filter box includes: a first air inflow surface exposed through the first opening; a first air discharge surface opposite to the first air inflow surface; and first moisture absorbents between the first air inflow surface and the first air discharge surface, wherein each of the first air inflow surface and the first air discharge surface comprises a hole.

In an embodiment of the inventive concept, a computer system includes: a computer device; a socket box spaced apart from the computer device; and a cable configured to electrically connect the computer device to the socket box, wherein the socket box includes a power switch and a monitor port.

In an embodiment of the inventive concept, a method for operating a computer device includes: measuring a first measurement value of humidity of an inner space of a case and a second measurement value of humidity of an inner space of an intake filter box; determining whether a calculated value obtained by subtracting the first measurement value from the second measurement value is greater than or equal to a first set value; supplying current to a heating wire surrounding the intake filter box when the calculated value is greater than or equal to the first set value; measuring a third measurement value of a temperature of the inner space of the case; determining whether the third measurement value is greater than or equal to a second set value; and stopping the supply of the current to the heating wire when the third measurement value is greater than or equal to the second set value, wherein air outside the case is introduced into the inner space of the case through the intake filter box.

In an embodiment of the inventive concept, a method for operating a computer device includes: measuring a first measurement value of humidity of an inner space of a case; determining whether the first measurement value is greater than or equal to a first set value; supplying current to a heating wire surrounding an intake filter box when the first measurement value is greater than or equal to the first set value; measuring a second measurement value of a temperature of the inner space of the case and a third measurement value of humidity of the inner space of the case; determining whether the third measurement value is less than a third set value when the second measurement value is less than a second set value; and stopping the supply of the current to the heating wire when the third measurement value is less than the third set value, wherein air outside the case is introduced into the inner space of the case through the intake filter box.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a perspective view illustrating an outer appearance of a computer device according to some embodiments;

FIGS. 2, 3, and 4 are views for explaining components within a case;

FIGS. 5A, 5B, 5C, 5D, 5E, and 5F are views for explaining an intake filter box;

FIGS. 6A, 6B, 6C, and 6D are views for explaining an exhaust filter box;

FIG. 7 is a view for explaining a computer system including a computer device;

FIG. 8 is a view for explaining a socket box;

FIG. 9 is a flowchart illustrating a method for operating a computer device according to some embodiments;

FIG. 10 is a flowchart illustrating a method for operating a computer device according to some embodiments; and

FIGS. 11, 12, and 13 are tables showing results of temperature and humidity measurement experiments of a computer device according to an embodiment of the inventive concept and a computer device according to a comparative example.

### DETAILED DESCRIPTION

Hereinafter, embodiments of the inventive concept will be described in detail with reference to the accompanying drawings.

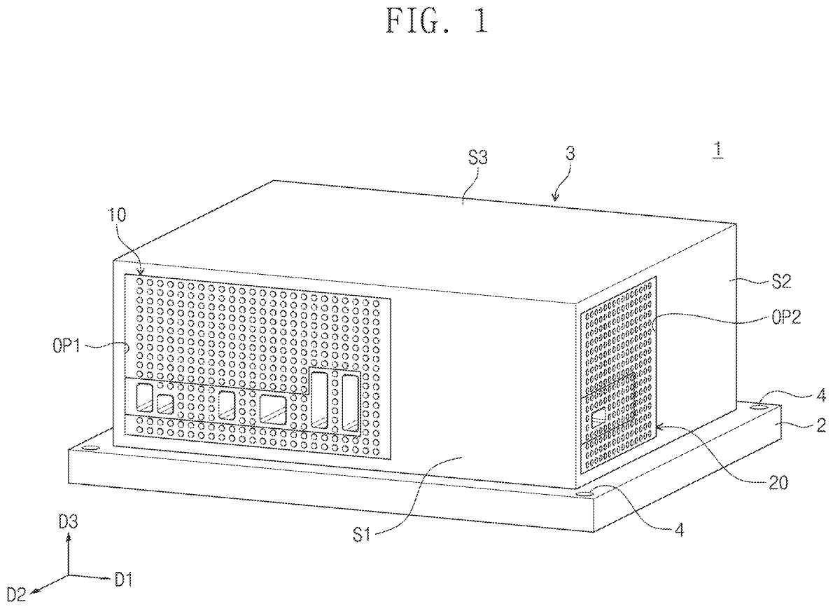

FIG. 1 is a perspective view illustrating an outer appearance of a computer device according to some embodiments.

Referring to FIG. 1, a computer device 1 may include a base plate 2 and a case 3 on the base plate 2. The base plate 2 may be expanded in a first direction D1 and a second direction D2. The first direction D1 and the second direction D2 may cross each other. For example, the first direction D1 and the second direction D2 may be horizontal directions orthogonal to each other.

An empty inner space may be provided inside the case 3. The case 3 may serve to protect components inside the case 3. The case 3 may surround the components inside the case 3. The case 3 may have a rectangular parallelepiped shape. The case 3 may be fixed to the base plate 2.

The base plate 2 may include coupling openings 4 passing through the base plate 2. The computer device 1 may be fixed to a wall or ceiling by coupling bolts, for example, to the coupling openings 4.

The case 3 may include a first sidewall S1 parallel to the first direction D1 and a third direction D3, a second sidewall S2 parallel to the second direction D2 and the third direction D3, and a third sidewall S3 parallel to the first direction D1 and the second direction D2. The third direction D3 may cross the first direction D1 and the second direction D2. For example, the third direction D3 may be a vertical direction perpendicular to the first direction D1 and the second direction D2. The first sidewall S1, the second sidewall S2, and the third sidewall S3 of the case 3 may be connected to each other.

The first sidewall S1 of the case 3 may include a first opening OP1. The first air inflow surface 12 of the intake filter box 10, which will be described later, may be exposed through the first opening OP1. The second sidewall S2 of the case 3 may include a second opening OP2. The second air discharge surface 23 of the exhaust filter box 20, which will be described later, may be exposed through the second opening OP2. The case 3 may be sealed except for the first and second openings OP1 and OP2.

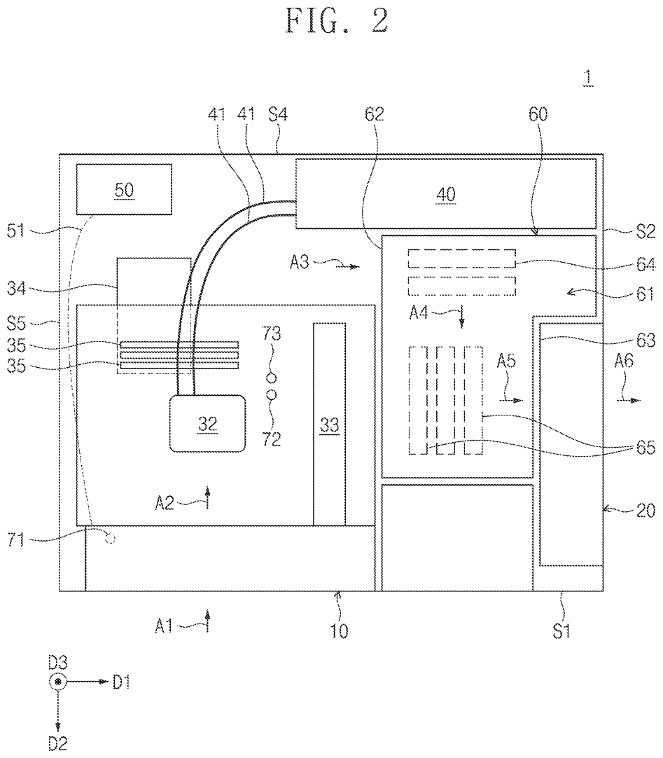

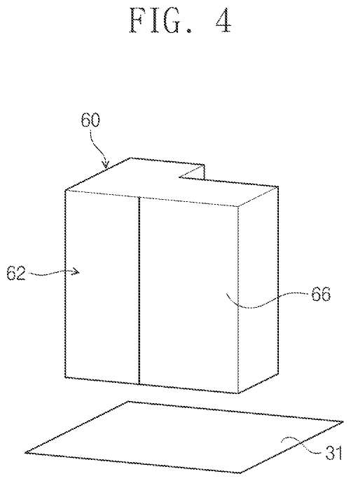

FIGS. 2, 3, and 4 are views for explaining components within the case.

Referring to FIGS. 2, 3, and 4, the intake filter box 10, the exhaust filter box 20, a main board 31, a central processing unit (CPU) 32, a graphic card 33, a main storage device 34, an auxiliary storage device 35, a power supply unit 36, a CPU cooler 40, a temperature and humidity controller 50, and an air control unit 60 may be provided in the case 3.

The case 3 may further include a fourth sidewall S4 parallel to the first direction D1 and the third direction D3 and a fifth sidewall S5 parallel to the second direction D2 and the third direction D3. The fourth sidewall S4 may be a sidewall opposite to the first sidewall S1. The fifth sidewall S5 may be a sidewall opposite to the second sidewall S2. The first and fourth sidewalls S1 and S4 may be spaced apart from each other in the second direction D2 with the intake filter box 10, the exhaust filter box 20, the main board 31, the CPU 32, the graphic card 33, the main storage device 34, the auxiliary storage device 35, the power supply unit 36, the CPU cooler 40, the temperature and humidity controller 50, and the air control unit 60 therebetween. The second and fifth sidewalls S2 and S5 may be spaced apart from each other in the first direction D1 with the intake filter box 10, the exhaust filter box 20, the main board 31, the CPU 32, the graphic card 33, the main storage device 34, the auxiliary storage device 35, the power supply device 36, the CPU cooler 40, the temperature and humidity controller 50, and the air control unit 60 therebetween.

The intake filter box 10 may be disposed adjacent to the first sidewall S1 of the case 3. The exhaust filter box 20 may be disposed adjacent to the second sidewall S2 of the case 3. The intake filter box 10 and the exhaust filter box 20 may be spaced apart from each other in the first direction D1.

The main board 31 may be spaced apart from the first sidewall S1 in the second direction D2. The intake filter box 10 may be disposed between the main board 31 and the first sidewall S1. The main board 31 may be spaced apart from the second sidewall S2 in the first direction D1. The exhaust filter box 20 may be disposed between the main board 31 and the second sidewall S2.

The temperature and humidity controller 50 may be disposed adjacent to the fourth sidewall S4 and the fifth sidewall S5. The CPU cooler 40 may be disposed adjacent to the second sidewall S2 and the fourth sidewall S4. The temperature and humidity controller 50 may be disposed between the fourth sidewall S4 and the main board 31. The CPU cooler 40 may be disposed between the fourth sidewall S4 and the main board 31. The temperature and humidity controller 50 and the CPU cooler 40 may be spaced apart from each other in the first direction D1.

The power supply device 36 may be disposed adjacent to the first sidewall S1. The power supply device 36 may be disposed between the intake filter box 10 and the exhaust filter box 20. The power supply device 36 may be disposed between the main board 31 and the exhaust filter box 20.

The air control device 60 may be disposed between the main board 31 and the exhaust filter box 20. The air control device 60 may be disposed adjacent to the main board 31. The air control device 60 may be disposed between the CPU cooler 40 and the power supply device 36. The air control device 60 may be spaced apart from the first sidewall S1 and the fourth sidewall S4 in the second direction D2.

The main board 31 may be electrically connected to the CPU 32, the graphic card 33, the main storage device 34, the auxiliary storage device 35, the power supply device 36, the intake filter box 10, the exhaust filter box 20, the temperature and humidity controller 50, the CPU cooler 40, and the air control device 60.

The power supply device 36 may be connected to an external power source to supply power to the main board 31. The power may be supplied to the CPU 32, the graphic card 33, the main storage device 34, the auxiliary storage device 35, the intake filter box 10, the temperature and humidity controller 50, the CPU cooler 40, and the air control device through the main board 31.

The main storage device 34 may store data non-volatilely. The main storage device 34 may be, for example, a hard disk or solid state disk (SSD). The auxiliary storage device 35 may store data volatilely. The auxiliary storage device 35 may be, for example, a dynamic random access memory (DRAM). The CPU 32 may process data. The graphic card 33 may process graphic tasks.

The computer device 1 may further include a first humidity sensor 71, a second humidity sensor 72, and a temperature sensor 73. The first humidity sensor 71 may be disposed within the intake filter box 10. The second humidity sensor 72 and temperature sensor 73 may be disposed within the case 3. The second humidity sensor 72 and temperature sensor 73 may be connected to the main board 31.

The CPU cooler 40 may serve to cool the CPU 32. In some embodiments, the CPU cooler 40 may be a water-cooling type cooler and may cool the CPU 32 in a water-cooling manner through connection tubes 41 connected to the CPU 32.

The temperature and humidity controller 50 may be electrically connected to the first humidity sensor 71, the second humidity sensor 72, and the temperature sensor 73. The temperature and humidity controller 50 may receive signals from the first humidity sensor 71, the second humidity sensor 72, and the temperature sensor 73. The temperature and humidity controller 50 may control a heating wire 11 of the intake filter box 10, which will be described later. The temperature and humidity controller 50 and the heating wire 11 may be electrically connected by a wire 51.

An empty inner space 61 may be provided inside the air control device 60. The air control device 60 may control a flow of air using an air inlet 62, an air outlet 63, first cooling fans 64, and second cooling fans 65.

The air may be introduced from the outside of the air control device 60 into the inner space 61 of the air control device 60 through the air inlet 62. The air may be discharged from the inner space 61 of the air control device 60 to the outside of the air control device 60 through the air outlet 63. The air inlet 62 may be disposed adjacent to the main board 31. The air outlet 63 may be disposed adjacent to the exhaust filter box 20. The air inlet 62 and the air outlet 63 may be connected to each other by an inner space 61.

The first cooling fans 64 may be disposed adjacent to the air inlet 62. The first cooling fans 64 may be spaced apart from the air inlet 62 in the first direction D1. The first cooling fans 64 may allow air to flow in the second direction D2. In some embodiments, the first cooling fans 64 may include fans rotating on a plane parallel to the first direction D1 and the third direction D3.

The second cooling fans 65 may be disposed adjacent to the air outlet 63. The second cooling fans 65 may be spaced apart from the air outlet 63 in the first direction D1. The second cooling fans 65 may be spaced apart from the first cooling fans 64 in the second direction D2. The second cooling fans 65 may allow air to flow in the first direction D1. In some embodiments, the second cooling fans 65 may include fans rotating on a plane parallel to the second direction D2 and the third direction D3.

The air outside the case 3 may be introduced into the case 3 and then be discharged from the inside of the case 3 to the outside of the case 3 by the air control device 60. The air outside the case 3 may flow into the case 3 through the intake filter box 10 (A1). The air passing through the intake filter box 10 may flow along front and rear surfaces of the main board 31 (A2). The air flowing along the main board 31 may be introduced into the air control device 60 through the air inlet 62 of the air control device 60 (A3).

The air control device 60 may include a flow sidewall 66 adjacent to the main board 31. The flow sidewall 66 may be parallel to, for example, the second direction D2 and the third direction D3. The flow sidewall 66 may be disposed closer to the main board 31 than the air inlet 62. As the air control device 60 includes the flow sidewall 66, the air introduced into the case 3 may not flow directly into the air control device 60, but flow along the main board 31 and then be introduced into the air inlet 62.

The air introduced into the air control device 60 may flow in the second direction D2 by the first cooling fans 64 (A4). The air passing through the first cooling fans 64 may flow in the first direction D1 by the second cooling fans 65 (A5). The air passing through the second cooling fans 65 may be discharged to the exhaust filter box 20 through the air outlet 63. The air passing through the exhaust filter box 20 may be discharged to the outside of the case 3 (A6).

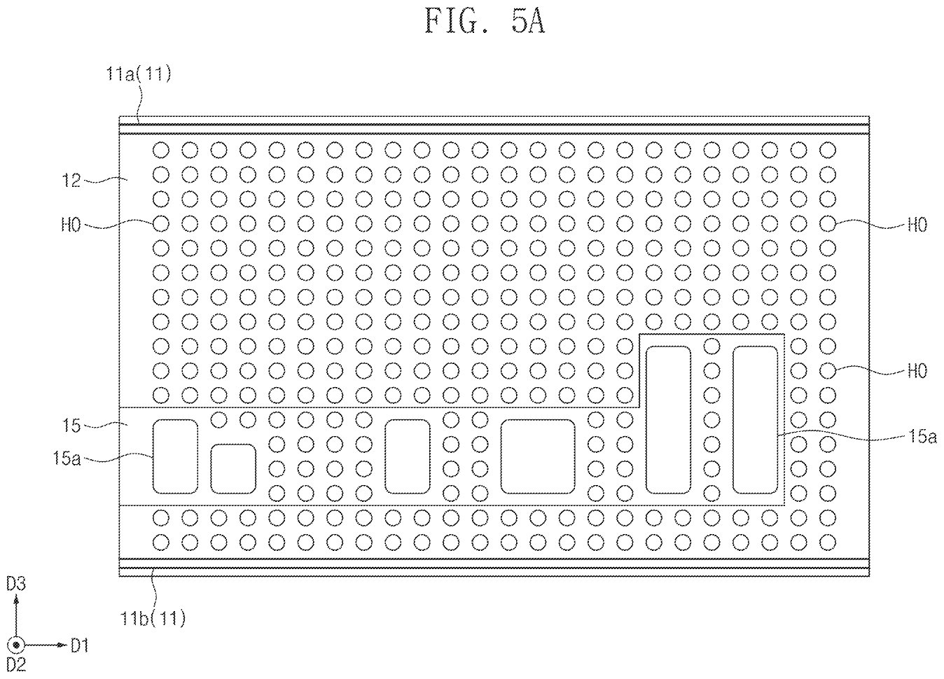

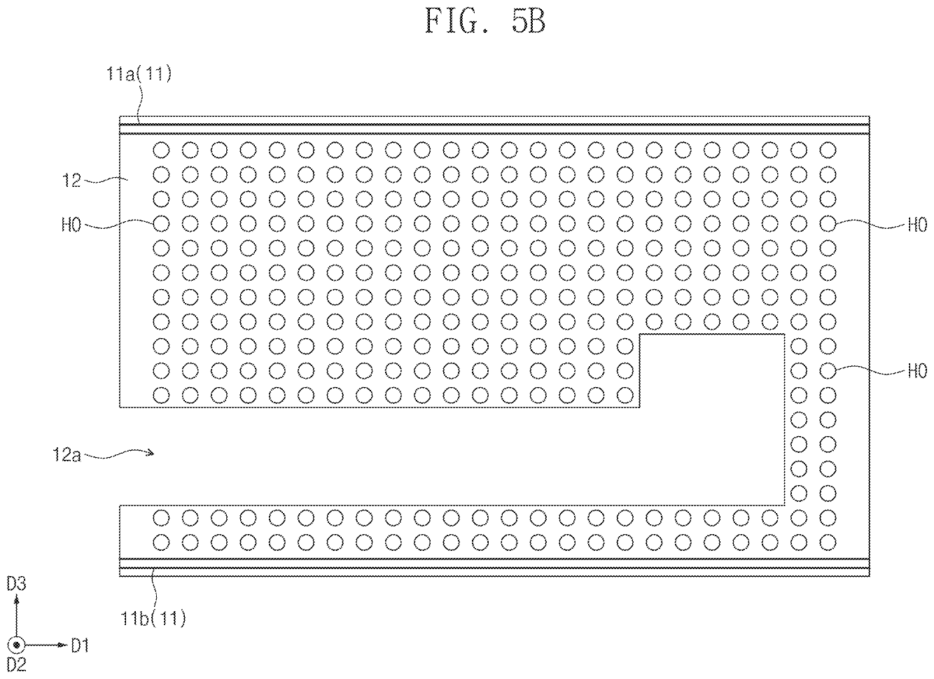

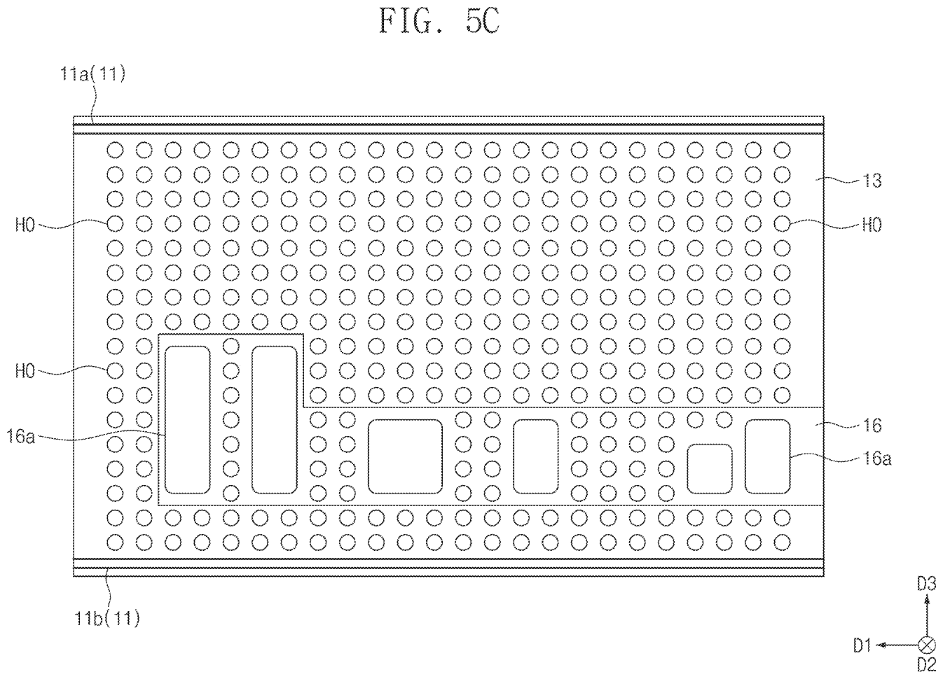

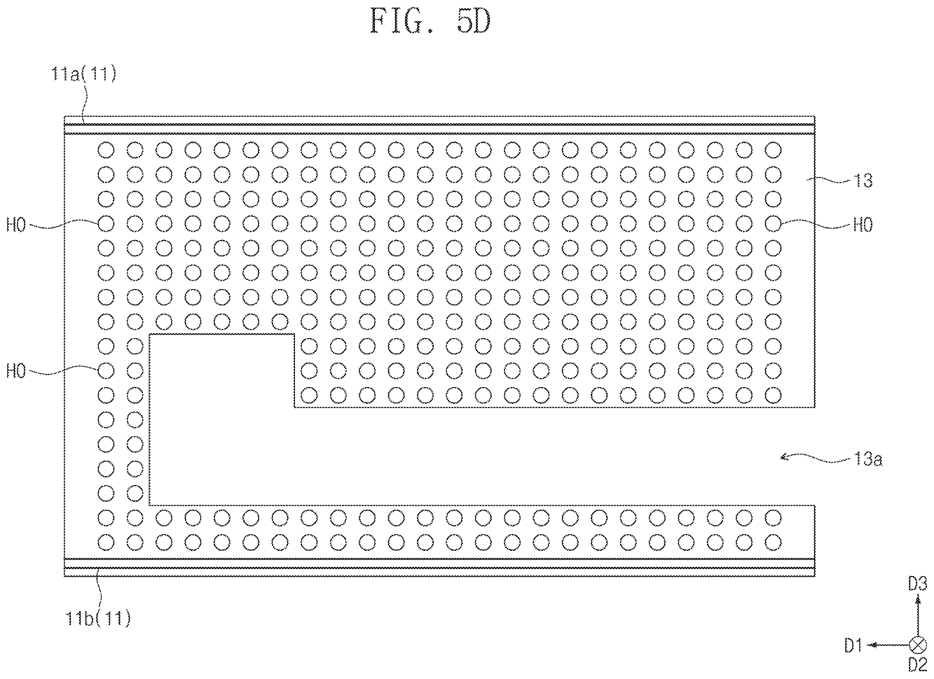

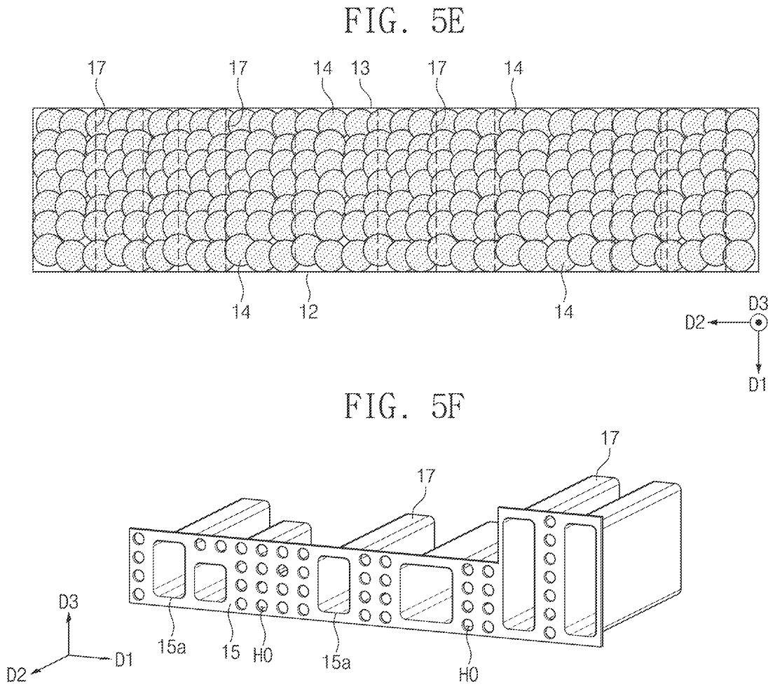

FIGS. 5A, 5B, 5C, 5D, 5E, and 5F are views for explaining the intake filter box.

Referring to FIGS. 5A, 5B, 5C, 5D, 5E and 5F, the intake filter box 10 may include a first air inflow surface 12, a first air discharge surface 13, a heating wire 11, a first moisture absorbents 14, a first terminal connection plate 15, a second terminal connection plate 16, and first terminal connection tubes 17.

For example, the first air inflow surface 12 and the first air discharge surface 13 may be parallel to the first direction D1 and the third direction D3. The first air inflow surface 12 and the first air discharge surface 13 may be spaced apart from each other in the second direction D2. The first air inflow surface 12 and the first air discharge surface 13 may be opposite to each other. The intake filter box 10 may further include four surfaces between the first air inflow surface 12 and the first air discharge surface 13.

The air may be introduced into the intake filter box 10 from the outside of the case 3 through the first air inflow surface 12. The first terminal connection plate 15 may be coupled to the first air inflow surface 12. The first air inflow surface 12 may include a first coupling opening 12a having a shape similar to that of the first terminal connection plate 15, and the first terminal connection plate 15 may include a first coupling opening 12a. In some embodiments, the first terminal connection plate 15 may be coupled to the first air inflow surface 12 by a coupling member (e.g., a bolt), and the coupling member may be released to separate the first terminal connection plate 15 from the first air inflow surface 12.

The first air inflow surface 12 and the first terminal connection plate 15 may include holes HO. The air may be introduced into the intake filter box 10 from the outside of the case 3 through the holes HO of the first air inflow surface 12 and the first terminal connection plate 15.

The first terminal connection plate 15 may include first terminal connection openings 15a. A size of the first terminal connection opening 15a may be greater than that of each of the holes HO. For example, an area of the first terminal connection opening 15a may be greater than that of the hole HO.

In some embodiments, the first air inflow surface 12 may include the first terminal connection openings 15a without the first terminal connection plate 15.

The air may be discharged from the intake filter box 10 toward the main board 31 through the first air discharge surface 13. The second terminal connection plate 16 may be coupled to the first air discharge surface 13. The first air discharge surface 13 may include a second coupling opening 13a having a shape similar to that of the second terminal connection plate 16, and the second terminal connection plate 16 may include a second coupling opening 13a. In some embodiments, the second terminal connection plate 16 may be coupled to the first air discharge surface 13 by a coupling member (e.g., a bolt), and the coupling member may be released to separate the second terminal connection plate 16 from the first air discharge surface 13.

The first air discharge surface 13 and the second terminal connection plate 16 may include holes HO. The air may be discharged from the intake filter box 10 toward the main board 31 through the holes HO of the first air discharge surface 13 and the second terminal connection plate 16. In some embodiments, a size of each of the holes HO of the first air discharge surface 13 and the second terminal connection plate 16 may be less than that of each of the holes HO of the first air inflow surface 12 and the first terminal connection plate 15.

Four surfaces between the first air inflow surface 12 and the first air discharge surface 13 of the intake filter box 10 may not include the hole HO.

The second terminal connection plate 16 may include second terminal connection openings 16a. A size of the second terminal connection opening 16a may be greater than that of each of the holes HO. For example, an area of the second terminal connection opening 16a may be greater than that of the hole HO.

In some embodiments, the first air discharge surface 13 may include the second terminal connection openings 16a without the second terminal connection plate 16.

The first terminal connection tubes 17 may be disposed between the first terminal connection plate 15 and the second terminal connection plate 16. Each of the first terminal connection tubes 17 may be connected to the first terminal connection plate 15 and the second terminal connection plate 16. The first terminal connection tube 17 may be connected to the first terminal connection opening 15a and the second terminal connection opening 16a. The first terminal connection tube 17 may have a shape of a hollow pipe. Terminals of the main board 31 and terminals of the graphic card may be exposed through the first terminal connection opening 15a, the first terminal connection tube 17, and the second terminal connection opening 16a.

The first moisture absorbents 14 may be filled into the space within the intake filter box 10. The first moisture absorbents 14 may be provided between the first air inflow surface 12 and the first air discharge surface 13. A diameter of each of the first moisture absorbents 14 may be greater than that of each of the holes HO. For example, the diameter of each of the first moisture absorbents 14 may be about 5 mm.

Each of the first moisture absorbents 14 may include a material capable of absorbing moisture. As an example, each of the first moisture absorbents 14 may include ceramic. The first moisture absorbents 14 may not be provided in the first terminal connection tube 17. The moisture may be removed from the air flowing into the intake filter box 10 by the first moisture absorbents 14. The first moisture absorbents 14 may block dust from being introduced into the case 3.

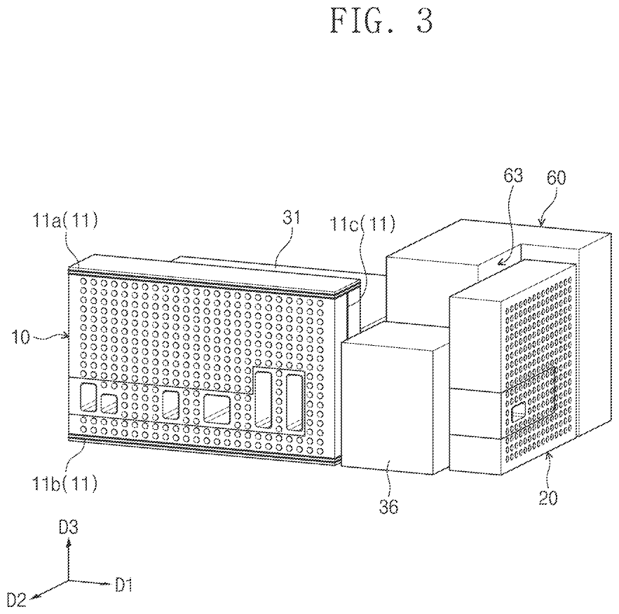

The heating wire 11 may surround the intake filter box 10. The heating wire 11 may surround the first air inflow surface 12 and the first air discharge surface 13. The heating wire 11 may include a first portion 11a surrounding an upper portion of the intake filter box 10, a second portion 11b surrounding a lower portion of the intake filter box 10, and a first portion 11c (see FIG. 3) connecting the first portion 11a to the second portion 11b. The heating wire 11 may include a material of which a temperature increases as current is applied.

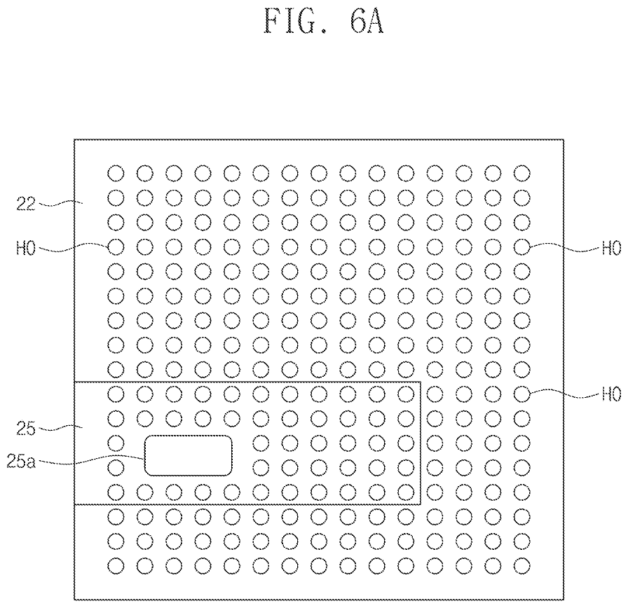

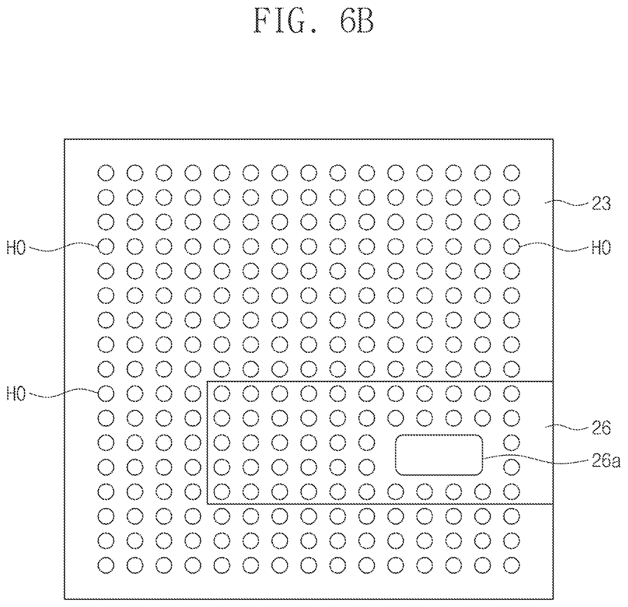

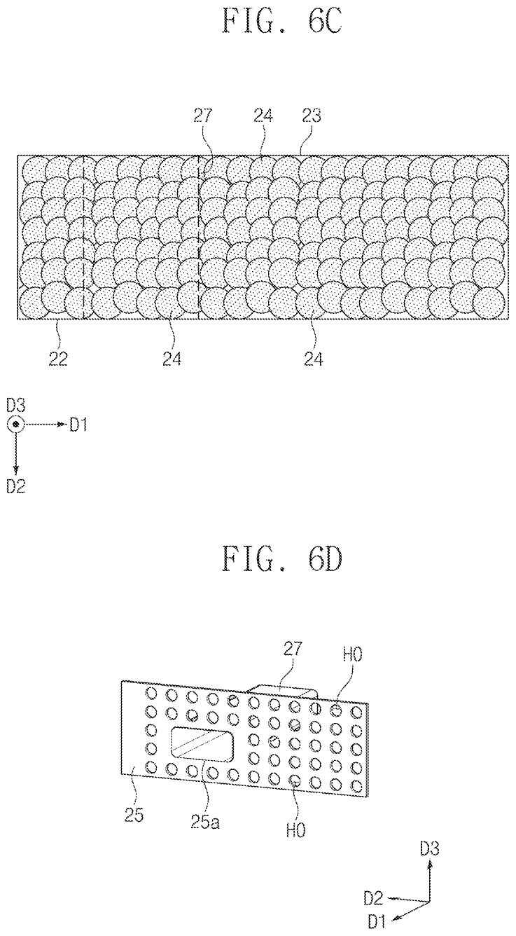

FIGS. 6A, 6B, 6C, and 6D are views for explaining the exhaust filter box.

Referring to FIGS. 6A, 6B, 6C and 6D, the exhaust filter box 20 may include a second air inflow surface 22, a second air discharge surface 23, second moisture absorbents 24, a third terminal connection plate 25, a fourth terminal connection plate 26, and a second terminal connection tube 27.

For example, the second air inflow surface 22 and the second air discharge surface 23 may be parallel to the second direction D2 and the third direction D3. The second air inflow surface 22 and the second air discharge surface 23 may be spaced apart from each other in the first direction D1. The second air inflow surface 22 and the second air discharge surface 23 may be opposite to each other. The exhaust filter box 20 may further include four surfaces between the second air inflow surface 22 and the second air discharge surface 23.

The air may be introduced from the air control device 60 to the exhaust filter box 20 through the second air inflow surface 22. The third terminal connection plate 25 may be coupled to the second air inflow surface 22. Similar to the first air inflow surface 12, the second air inflow surface 22 may include a third coupling opening having a shape similar to that of the third terminal connection plate 25, and the third terminal connection plate 25 may be coupled to the third coupling opening. In some embodiments, the third terminal connection plate 25 may be coupled to the second air inflow surface 22 by a coupling member (e.g., a bolt), and the coupling member may be released to separate the third terminal connection plate 25 from the second air inflow surface 22.

The second air inflow surface 22 and the third terminal connection plate 25 may include holes HO. The air may be introduced into the exhaust filter box 20 from the air control device 60 through the holes HO of the second air inflow surface 22 and the third terminal connection plate 25.

The third terminal connection plate 25 may include a third terminal connection opening 25a. A size of the third terminal connection opening 25a may be greater than that of each of the holes HO. For example, an area of the third terminal connection opening 25a may be greater than that of the hole HO.

In some embodiments, the second air inflow surface 22 may include the third terminal connection opening 25a without the third terminal connection plate 25.

The air may be discharged from within the exhaust filter box 20 to the outside of the case 3 through the second air discharge surface 23. The fourth terminal connection plate 26 may be coupled to the second air discharge surface 23. Similar to the first air discharge surface 13, the second air discharge surface 23 may include a fourth coupling opening having a shape similar to that of the fourth terminal connection plate 26, and the fourth terminal connection plate 26 may be coupled to the fourth coupling opening. In some embodiments, the fourth terminal connection plate 26 may be coupled to the second air discharge surface 23 by a coupling member (e.g., a bolt), and the coupling member may be released to separate the fourth terminal connection plate 26 from the second air discharge surface 23.

The second air discharge surface 23 and the fourth terminal connection plate 26 may include holes HO. The air may be discharged from within the exhaust filter box 20 to the outside of the case 3 through the holes HO of the second air discharge surface 23 and the fourth terminal connection plate 26.

The four surfaces between the second air inflow surface 22 and the second air discharge surface 23 of the exhaust filter box 20 may not include the hole HO.

The fourth terminal connection plate 26 may include a fourth terminal connection opening 26a. A size of the fourth terminal connection opening 26a may be greater than that of each of the holes HO. For example, an area of the fourth terminal connection opening 26a may be greater than that of the hole HO.

In some embodiments, the second air discharge surface 23 may include the fourth terminal connection opening 26a without the fourth terminal connection plate 26.

The second terminal connection tube 27 may be disposed between the third terminal connection plate 25 and the fourth terminal connection plate 26. The second terminal connection tube 27 may be connected to the third terminal connection plate 25 and the fourth terminal connection plate 26. The second terminal connection tube 27 may be connected to the third terminal connection opening 25a and the fourth terminal connection opening 26a. The second terminal connection tube 27 may have the shape of a hollow pipe. The terminal of the power supply device 36 may be exposed through the third terminal connection opening 25a, the second terminal connection opening 27, and the fourth terminal connection opening 26a. The power cable may connect an external power source to the terminal of the power supply device 36 through the third terminal connection opening 25a, the second terminal connection tube 27, and the fourth terminal connection opening 26a.

The second moisture absorbents 24 may be filled into the space within the exhaust filter box 20. The second moisture absorbents 24 may be provided between the second air inflow surface 22 and the second air discharge surface 23. A size of each of the second moisture absorbents 24 may be greater than that of each of the holes HO. For example, a diameter of each of the second moisture absorbents 24 may be greater than that of each of the holes HO.

Each of the second moisture absorbents 24 may include a material capable of absorbing moisture. As an example, each of the second moisture absorbents 24 may include ceramic. The second moisture absorbents 24 may not be provided in the second terminal connection tube 27.

As the computer device according to some embodiments includes the intake filter box 10 and the exhaust filter box 20, an inflow of the moisture and dust into the computer device may be prevented or improved. Thus, the computer device may be disposed in a place or environment with high humidity and dust, and the computer device may be disposed relatively freely.

As the computer device according to some embodiments may include the air control device 60, the air introduced into the computer device may sufficiently flow and then be discharged. Thus, the computer device may be protected from the high humidity and the high temperature.

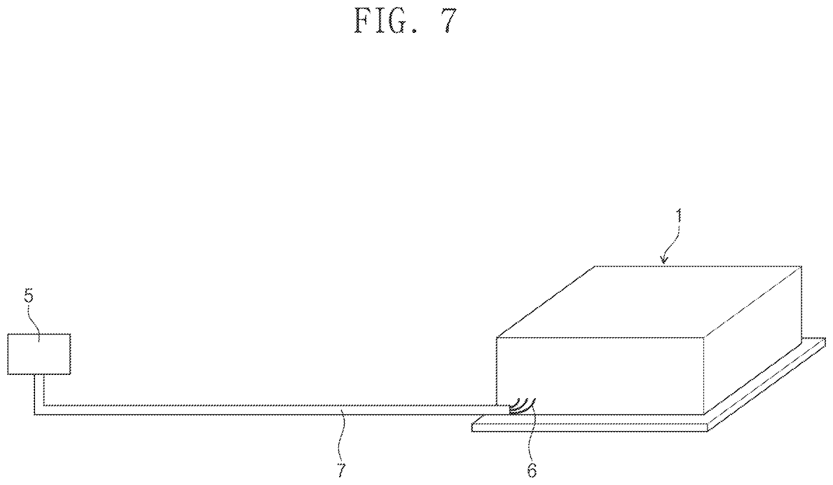

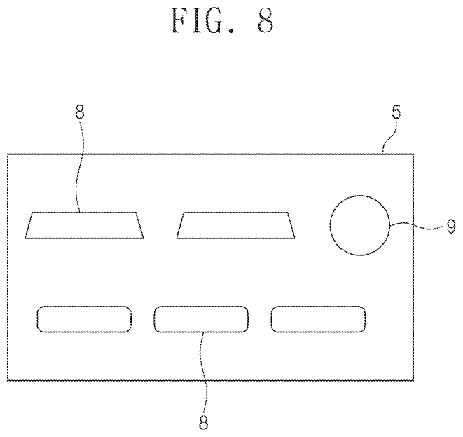

FIG. 7 is a view for explaining a computer system including the computer device. FIG. 8 is a view for explaining a socket box.

Referring to FIGS. 7 and 8, a computer system may include a computer device 1, a socket box 5, cables 6, and a cable connection tube 7. The socket box 5 may be spaced apart from the computer device 1. The socket box 5 may be disposed adjacent to a user input/output device (e.g., a monitor, a keyboard, or a mouse). The socket box 5 and the computer device 1 may be electrically connected to each other via the cables 6. The cable connection tube 7 may surround the cables 6. The cable 6 may be connected to the terminal of the main board or the terminal of the graphic card through the first terminal connection opening 15a (see FIGS. 5A to 5F), the first terminal connection tube 17 (see FIGS. 5A to 5F), and the second terminal connection opening 16a (see FIGS. 5A to 5F).

Each of the cables 6 and the cable connection tube 7 may have a relatively long length. For example, the length of each of the cables 6 and cable connection tube 7 may be more than about 5 m. Thus, the computer device 1 may be disposed at a relatively long distance from the socket box 5 and the user input device.

The cable 6 may be an optical cable. For example, the cable 6 may be an optical high definition multimedia interface (HDMI) cable or an optical universal serial bus (USB) cable. The cable 6 may have an automatic signal regeneration function. Even if the length of the cable 6 is relatively long, a signal may be transmitted stably by providing the automatic signal regeneration function. The signal transmitted through the cable 6 may undergo a current-to-light conversion process and an optical-to-current conversion process.

The socket box 5 may include a plurality of ports 8. The port 8 may be connected to the computer device 1 by the cable 6. The port 8 may include a monitor port. The port 8 may be, for example, an HDMI port, a USB port, a local area network (LAN) port, an audio port, or a printer port. The socket box 5 may further include a power switch 9. The power of the computer device 1 may be turned on according to an operation of the power switch 9.

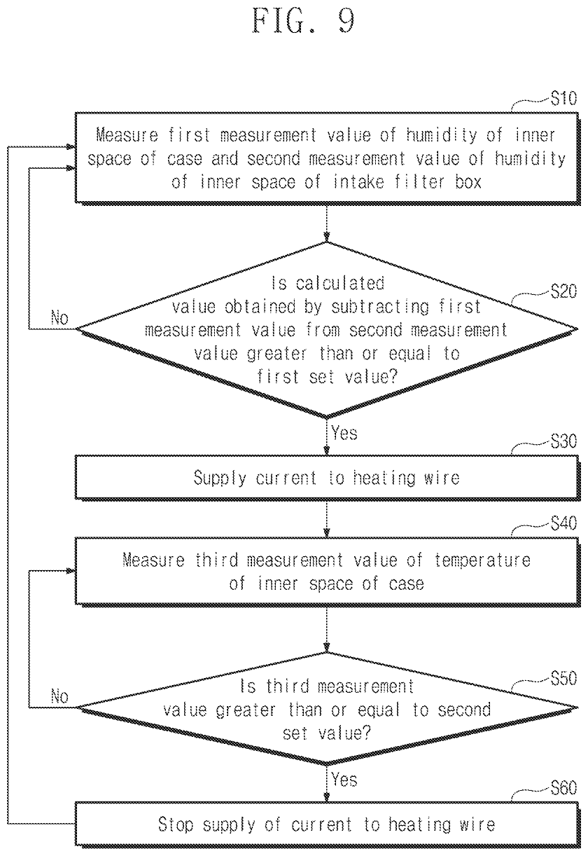

FIG. 9 is a flowchart illustrating a method for operating a computer device according to some embodiments.

Referring to FIG. 9, a first measurement value of humidity of an inner space of a case 3 of a computer device and a second measurement value of humidity of an inner space of an intake filter box 10 may be measured (S10). The humidity of the inner space of the case 3 may be measured by a second humidity sensor 72. The humidity of the inner space of the intake filter box 10 may be measured by a first humidity sensor 71.

It is determined whether a calculated value V1 obtained by subtracting the first measurement value of the humidity of the inner space of the case 3 from the second measurement value of the humidity of the inner space of the intake filter box 10 is greater than or equal to a first set value V2 (S20). For example, the first set value V2 may be set to about 10% of the first measurement value of the humidity of the inner space of the case 3, and when the calculated value V1 is about 10% or more of the first measurement value of the humidity of the inner space of case 3, it may be determined that the calculated value V1 is greater than or equal to the first set value V2. The temperature and humidity controller 50 may calculate the calculated value V1 and determine whether the calculated value V1 is greater than or equal to the first set value V2.

When the calculated value V1 is greater than or equal to the first set value V2, the temperature and humidity controller 50 may supply current to a heating wire 11 through a wire 51 (S30). The current may be supplied to the heating wire 11, and thus, the heating wire 11 may be heated, and the intake filter box 10 may be heated. As the intake filter box 10 is heated, first moisture absorbents 14 of the intake filter box 10 may be dried, and air introduced into the case 3 through the intake filter box 10 may decrease in humidity.

If the calculated value V1 is less than the first set value V2, the humidity of the inner space of the case 3 and the humidity of the inner space of the intake filter box 10 may be measured again after waiting for a predetermined time (S10). For example, the predetermined time may be about 1 hour.

After current is supplied to the heating wire 11, a third measurement value of the temperature of the inner space of the case 3 may be measured (S40). The temperature of the inner space of the case 3 may be measured by the temperature sensor 73. The temperature and humidity controller 50 may determine whether the third measurement value of the temperature of the inner space of the case 3 is greater than or equal to the second set value V3 (S50). For example, when the third measurement value of the temperature of the inner space of the case 3 is about 38° C. or more, it may be determined that the third measurement value of the temperature of the inner space of the case 3 is greater than the second set value V3.

When the third measurement value of the temperature of the inner space of the case 3 is greater than the second set value V3, the temperature and humidity controller 50 may stop the supply of the current to the heating wire 11 (S60). When the supply of the current to the heating wire 11 is stopped, the humidity of the inner space of the case 3 and the humidity of the inner space of the intake filter box 10 may be measured again after waiting for a predetermined time (S10).

If the third measurement value of the temperature of the inner space of the case 3 is less than the second set value V3, the temperature of the inner space of the case 3 may be measured again after waiting for a predetermined time (S40).

In a method of operating the computer device according to some embodiments, the computer device may be controlled so that the temperature and humidity inside the computer device do not rise above set values.

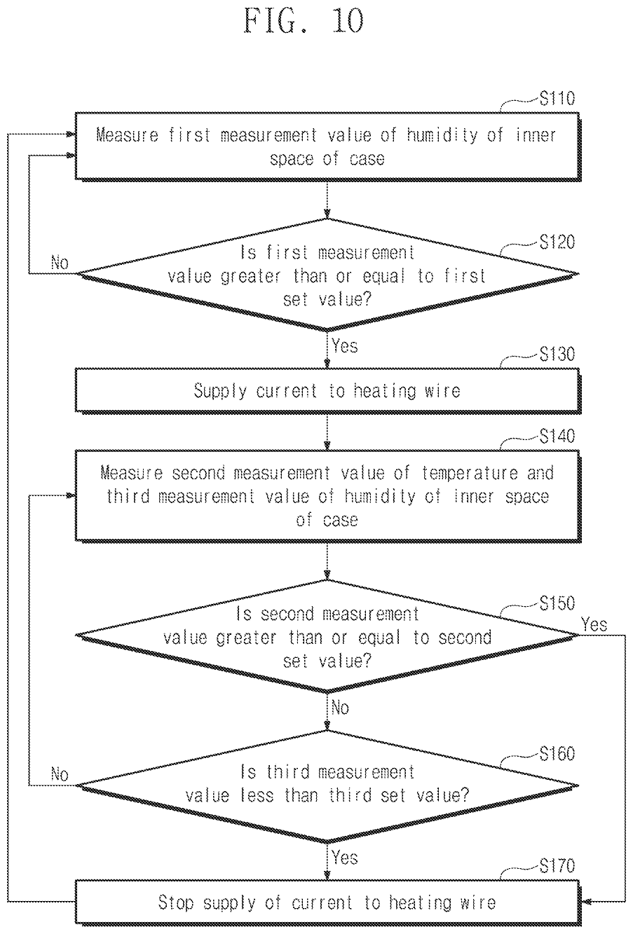

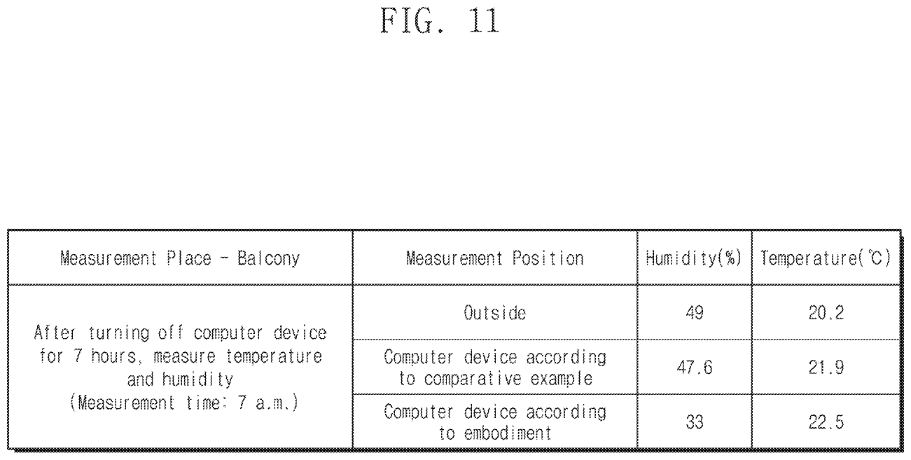

FIG. 10 is a flowchart illustrating a method for operating a computer device according to some embodiments.

Referring to FIG. 10, a first measurement value of humidity of an inner space of a case 3 of a computer device may be measured (S110). The humidity of the inner space of the case 3 may be measured by a second humidity sensor 72. In some embodiments, the computer device 1 may not include a first humidity sensor 71 within an intake filter box 10.

A temperature and humidity controller 50 may determine whether the first measurement value of the humidity of the inner space of the case 3 is greater than or equal to a first set value V4 (S120). When the first measurement value of the humidity of the inner space of the case 3 is greater than or equal to the first set value V4, the temperature and humidity controller 50 may supply current to a heating wire 11 through a wire 51 (S130). The current may be supplied to the heating wire 11, and thus, the heating wire 11 may be heated, and the intake filter box 10 may be heated. As the intake filter box 10 is heated, first moisture absorbents 14 of the intake filter box 10 may be dried, and air introduced into the case 3 through the intake filter box 10 may decrease in humidity.

If the first measurement value of the humidity of the inner space of the case 3 is less than the first set value V4, the humidity of the inner space of the case 3 may be measured again after waiting for a predetermined time (S110).

After the current is supplied to the heating wire 11, a second measurement value of the temperature and a third measurement value of the humidity of the inner space of the case 3 may be measured (S140). The temperature of the inner space of the case 3 may be measured by the temperature sensor 73.

The temperature and humidity controller 50 may determine whether the second measurement value of the temperature of the inner space of the case 3 is greater than or equal to the second set value V5 (S150). When the second measurement value of the temperature of the inner space of the case 3 is greater than or equal to the second set value V5, the temperature and humidity controller 50 may stop the supply of the current to the heating wire 11 (S170).

When the second measurement value of the temperature of the inner space of the case 3 is less than the second set value V5, the temperature and humidity controller 50 may determine whether the third measurement value of the humidity of the inner space of the case 3 is less than the third set value V6 (S160). When the third measurement value of the humidity of the inner space of the case 3 is less than the third set value V6, the temperature and humidity controller 50 may stop the supply of the current to the heating wire 11 (S170). If the third measurement value of the humidity of the inner space of the case 3 is greater than the third set value V6, the temperature and humidity of the inner space of the case 3 may be measured again after waiting for a predetermined time (S140).

When the supply of the current to the heating wire 11 is stopped, the humidity of the inner space of the case 3 may be measured again after waiting for a predetermined time (S110).

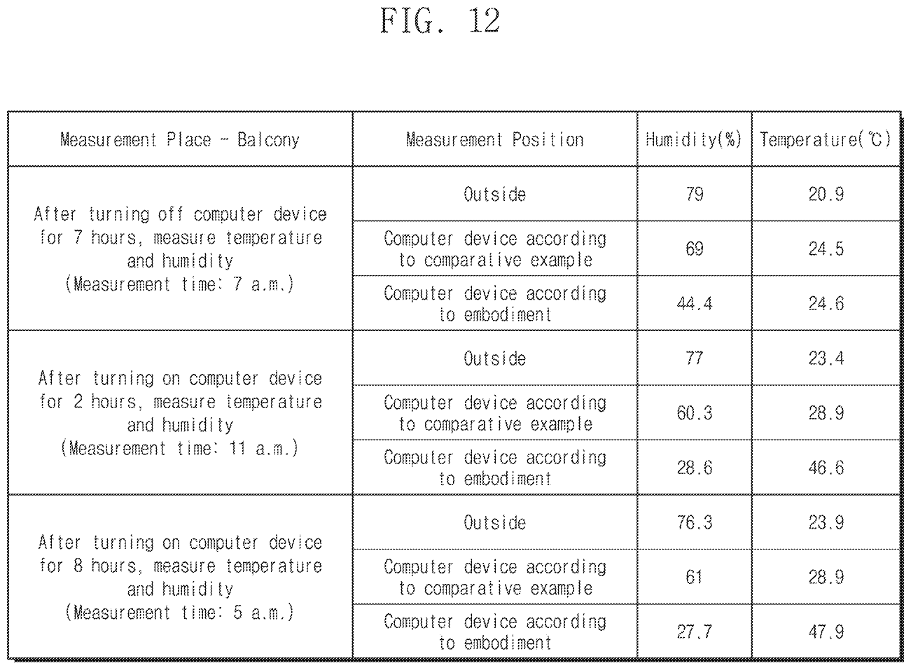

FIGS. 11, 12, and 13 are tables showing results of temperature and humidity measurement experiments of a computer device according to an embodiment of the inventive concept and a computer device according to a comparative example.

Referring to FIG. 11, a computer device according to an embodiment of the inventive concept and a computer device according to a comparative example were disposed on an outdoor balcony, and then, a temperature and humidity were measured. The weather on the measurement day was clear. The computer device according to the comparative example was a general computer device that did not include an intake filter box, an exhaust filter box, and a temperature and humidity controller. The computer devices were placed at 0:00 a.m., the computer devices were turned off for about 7 hours, and the temperature and humidity were measured at 7:00 a.m. As the results of the temperature and humidity measurement, a temperature outside (outdoor balcony) the computer devices was measured at about 20.2° C., a temperature inside the computer device according to an embodiment of the inventive concept was measured at about 22.5° C., a temperature inside the computer device according to a comparative example was measured at about 21.9° C., a humidity outside the computer devices was measured at about 49%, a humidity inside the computer device according to an embodiment of the inventive concept was measured at about 33%, and a humidity inside the computer device according to the comparative example was measured at about 47.6%.

As described above, it was confirmed that the computer device according to an embodiment of the inventive concept had relatively low humidity even when the computer device was not turned on.

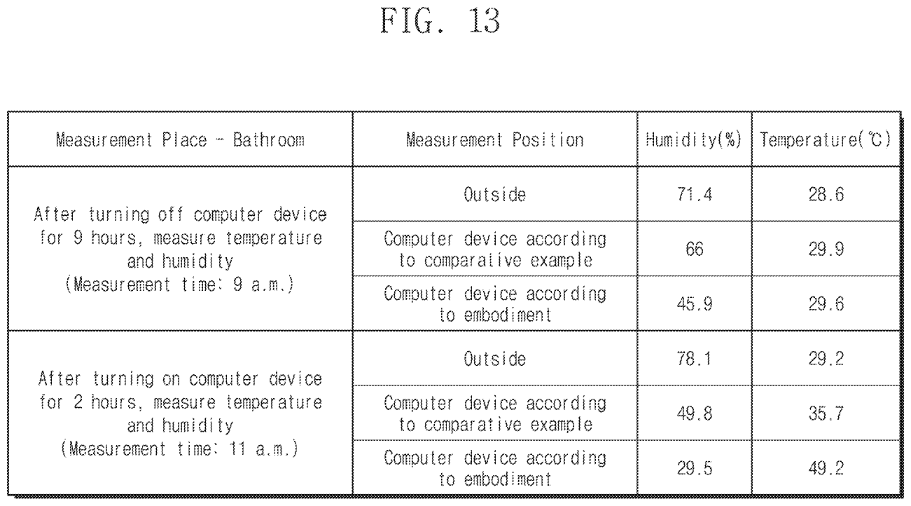

Referring to FIG. 12, a computer device according to an embodiment of the inventive concept and a computer device according to a comparative example were disposed on an outdoor balcony, and then, a temperature and humidity were measured. The weather on the measurement day was rainy. The computer devices were placed at 0:00 a.m., the computer devices were turned off for about 7 hours, and the temperature and humidity were measured at 7:00 a.m. As the results of the temperature and humidity measurement, a temperature outside the computer devices was measured at about 20.9° C., a temperature inside the computer device according to an embodiment of the inventive concept was measured at about 24.6° C., a temperature inside the computer device according to a comparative example was measured at about 24.5° C., a humidity outside the computer devices was measured at about 79%, a humidity inside the computer device according to an embodiment of the inventive concept was measured at about 44.4%, and a humidity inside the computer device according to the comparative example was measured at about 69%.

The computer devices were turned on at 9 a.m., the computer devices were turned on for about 2 hours, and the temperature and humidity were measured at 11 a.m. As the computer device according to an embodiment of the inventive concept was turned on, the temperature and humidity controller 50, the air control device 60, the CPU cooler 40, and the heating wire 11 operated as described above. As the results of the temperature and humidity measurement, a temperature outside the computer devices was measured at about 23.4° C., a temperature inside the computer device according to an embodiment of the inventive concept was measured at about 46.6° C., a temperature inside the computer device according to a comparative example was measured at about 28.9° C., a humidity outside the computer devices was measured at about 77%, a humidity inside the computer device according to an embodiment of the inventive concept was measured at about 28.6%, and a humidity inside the computer device according to the comparative example was measured at about 60.3%.

The computer devices were turned on at 9 a.m., the computer devices were turned on for about 8 hours, and the temperature and humidity were measured at 5 a.m. As the results of the temperature and humidity measurement, a temperature outside the computer devices was measured at about 23.9° C., a temperature inside the computer device according to an embodiment of the inventive concept was measured at about 47.9° C., a temperature inside the computer device according to a comparative example was measured at about 28.9° C., a humidity outside the computer devices was measured at about 77.3%, a humidity inside the computer device according to an embodiment of the inventive concept was measured at about 27.7%, and a humidity inside the computer device according to the comparative example was measured at about 61%.

As above, it was confirmed that the computer device according to an embodiment of the inventive concept has an improved humidity control ability after being turned on.

Referring to FIG. 13, the computer device according to an embodiment of the inventive concept and the computer device according to the comparative example were disposed in an indoor bathroom, a temperature and humidity of the bathroom were relatively high, and then the temperature and humidity were measured. The computer devices were placed at 0:00 a.m., the computer devices were turned off for about 9 hours, and the temperature and humidity were measured at 9:00 a.m. As the results of the temperature and humidity measurement, a temperature (temperature of bathroom) outside the computer devices was measured at about 28.6° C., a temperature inside the computer device according to an embodiment of the inventive concept was measured at about 29.6° C., a temperature inside the computer device according to a comparative example was measured at about 29.9° C., a humidity outside the computer devices was measured at about 71.4%, a humidity inside the computer device according to an embodiment of the inventive concept was measured at about 45.9%, and a humidity inside the computer device according to the comparative example was measured at about 66%.

The computer devices were turned on at 9 a.m., the computer devices were turned on for about 2 hours, and the temperature and humidity were measured at 11 a.m. As the results of the temperature and humidity measurement, a temperature outside the computer devices was measured at about 29.2° C., a temperature inside the computer device according to an embodiment of the inventive concept was measured at about 49.2° C., a temperature inside the computer device according to a comparative example was measured at about 35.7° C., a humidity outside the computer devices was measured at about 78.1%, a humidity inside the computer device according to an embodiment of the inventive concept was measured at about 29.5%, and a humidity inside the computer device according to the comparative example was measured at about 49.8%.

As above, it was confirmed that the computer device according to an embodiment of the inventive concept has a sufficient humidity control ability even if the computer device is disposed in a place at which the temperature is relatively high.

The computer device according to the embodiments of the inventive concept may include the intake filter box, the exhaust filter box, the air control device, and the temperature and humidity controller to control the humidity and the dust inside the computer device.

The computer device according to the embodiments of the inventive concept may include the intake filter box and the exhaust filter box to filter the dust and monitor the humidity, thereby confirming the dust filtering performance.

The computer system according to the embodiments of the inventive concept may include the socket box, and thus, the computer device may be disposed in the indoor or outdoor space without being affected by the humidity and dust.

Although the embodiment of the inventive concept is described with reference to the accompanying drawings, those with ordinary skill in the technical field of the inventive concept pertains will be understood that the present disclosure can be carried out in other specific forms without changing the technical idea or essential features. Therefore, the above-disclosed embodiments are to be considered illustrative and not restrictive.

What is claimed is:

1. A computer device comprising:
a case comprising a first opening;
an intake filter box exposed through the first opening of the case;
a main board within the case; and
a power supply device within the case,
wherein the intake filter box comprises:
a first air inflow surface exposed through the first opening;
a first air discharge surface opposite to the first air inflow surface; and
first moisture absorbents between the first air inflow surface and the first air discharge surface,
wherein each of the first air inflow surface and the first air discharge surface comprises a hole.

2. The computer device of claim 1, wherein each of the first moisture absorbents comprises ceramic.

3. The computer device of claim 1, wherein the intake filter box comprises:
a first terminal connection opening;
a first terminal connection tube connected to the first terminal connection opening; and
a second terminal connection opening connected to the first terminal connection tube,
wherein the first terminal connection tube has a shape of an empty pipe.

4. The computer device of claim 3, wherein each of the first and second terminal connection openings has a size greater than that of the hole.

5. The computer device of claim 3, wherein a terminal of the main board is exposed through the first terminal connection opening, the second terminal connection opening, and the first terminal connection tube.

6. The computer device of claim 1, wherein the intake filter box further comprises a heating wire configured to surround the first air inflow surface and the first air discharge surface.

7. The computer device of claim 6, further comprising a temperature and humidity controller electrically connected to the heating wire.

8. The computer device of claim 1, wherein the case further comprises a second opening, and
the computer device further comprises an exhaust filter box exposed through the second opening,
wherein the exhaust filter box comprises:
a second air discharge surface exposed through the second opening;
a second air inflow surface opposite to the second air discharge surface; and
second moisture absorbents between the second air inflow surface and the second air discharge surface.

9. The computer device of claim 8, wherein the exhaust filter box comprises:
a third terminal connection opening;
a second terminal connection tube connected to the third terminal connection opening; and
a fourth terminal connection opening connected to the second terminal connection tube,
wherein the second terminal connection tube has a shape of an empty pipe.

10. The computer device of claim 9, wherein a terminal of the power supply device is exposed through the third terminal connection opening, the fourth terminal connection opening, and the second terminal connection tube.

11. The computer device of claim 1, wherein the case further comprises a second opening, and
the computer device further comprises:
an exhaust filter box exposed through the second opening; and
an air control device between the exhaust filter box and the main board,
wherein the air control device comprises:
an air inlet adjacent to the main board;
an air outlet adjacent to the exhaust filter box; and
an inner space through which the air inlet and the air outlet are connected to each other.

12. The computer device of claim 11, wherein the air control device comprises a first cooling fan adjacent to the air inlet and a second cooling fan adjacent to the air outlet,
wherein the first cooling fan comprises a fan rotating on a plane parallel to a first direction and a second direction crossing the first direction, and
the second cooling fan comprises a fan rotating on a plane parallel to the second direction and a third direction crossing the second direction.

13. The computer device of claim 1, further comprising a first humidity sensor and a temperature sensor, which are connected to the main board.

14. The computer device of claim 13, further comprising a second humidity sensor within the intake filter box.

15. A computer system comprising:
a computer device;
a socket box spaced apart from the computer device; and
a cable configured to electrically connect the computer device to the socket box,
wherein the socket box comprises a power switch and a monitor port.

16. The computer system of claim 15, wherein the cable comprises an automatic signal regeneration function.

17. A method for operating a computer device, the method comprising:
measuring a first measurement value of humidity of an inner space of a case and a second measurement value of humidity of an inner space of an intake filter box;
determining whether a calculated value obtained by subtracting the first measurement value from the second measurement value is greater than or equal to a first set value;
supplying current to a heating wire surrounding the intake filter box when the calculated value is greater than or equal to the first set value;
measuring a third measurement value of a temperature of the inner space of the case;
determining whether the third measurement value is greater than or equal to a second set value; and
stopping the supply of the current to the heating wire when the third measurement value is greater than or equal to the second set value,
wherein air outside the case is introduced into the inner space of the case through the intake filter box.

18. The method of claim 17, further comprising:
measuring a fourth measurement value of the temperature of the inner space of the case after waiting for a predetermined time when the third measurement value is less than the second set value; and
determining whether the fourth measurement value is greater than or equal to the second set value.

19. A method for operating a computer device, the method comprising:
measuring a first measurement value of humidity of an inner space of a case;
determining whether the first measurement value is greater than or equal to a first set value;
supplying current to a heating wire surrounding an intake filter box when the first measurement value is greater than or equal to the first set value;
measuring a second measurement value of a temperature of the inner space of the case and a third measurement value of humidity of the inner space of the case;
determining whether the third measurement value is less than a third set value when the second measurement value is less than a second set value; and
stopping the supply of the current to the heating wire when the third measurement value is less than the third set value,
wherein air outside the case is introduced into the inner space of the case through the intake filter box.

20. The method of claim 19, further comprising stopping the supply of the current to the heating wire when the second measurement value is greater than or equal to the second set value.
